(19) United States
(12) Patent Application Publication
(10) Pub. No.: US 2002/0123965 A1
(43) Pub. Date: Sep. 5, 2002

(54) Method and system for electronic commerce using a mobile communication system

(76) Inventor: Joyce Phillips, Tokyo (JP)

Correspondence Address: KILPATRICK STOCKTON LLP, 607 14TH STREET, N.W., SUITE 900, WASHINGTON, DC, 20005, US

(21) Appl. No.: 10/078,669

(22) Filed: Feb. 21, 2002

Related U.S. Application Data
(60) Provisional application No. 60/168,031, filed on Nov. 30, 1999.
(60) Provisional application No. 60/205,318, filed on May 18, 2000.
(60) Provisional application No. 60/113,632, filed on Dec. 22, 1998.
(60) Provisional application No. 60/270,340, filed on Feb. 21, 2001.

(51) Int. Cl. G06F 17/60

(52) U.S. Cl. 705/41

(57) ABSTRACT

A system and method for using a smart card provided by a bank and available through a mobile telephone service provider in one branded service for use on a secure merchant network accessible through a mobile telephone whereby a consumer may obtain a single-branded smart card from the mobile telephone service provider and subsequently purchase goods and services through such a network using the smart card, and whereby the bank account or other account associated with the smart card is debited.

### Related Patent Applications

This application relates to U.S. Utility patent application Ser. No. 09/728,471, filed Nov. 30, 2000, U.S. Provisional Patent Application Ser. No. 60/168,031, filed Nov. 30, 1999, U.S. Provisional Patent Application Ser. No. 60/205,318, filed May 18, 2000, U.S. Utility patent application Ser. No. 09/468,945, filed Dec. 22, 1999, and U.S. Provisional Patent Application Ser. No. 60/113,632, filed Dec. 22, 1998, all of which are hereby incorporated by reference.

This application claims priority to and herein incorporates in its entirety U.S. Provisional Patent Application Ser. No. 60/270,340 filed Feb. 21, 2001.

### FIELD OF THE INVENTION

The present invention relates to electronic commerce using a mobile communications system, such as a mobile telephone.

### BACKGROUND

The use of mobile (or wireless) telephones has increased dramatically over the past several years. Moreover, the use of mobile telephones in electronic commerce has also increased. Mobile telephone service providers and others find it highly desirable to provide innovative services to their customers and potential customers.

Conventional means of using mobile telephones in electronic commerce, however, are based on a variety of standards and lack certain, desirable features. For example, conventional means of using mobile telephones in electronic commerce do not provide a combination of multiple financial products (e.g., credit lines, cash advance lines, and the like) on one smart card available through a mobile telephone service provider in one branded service for use on a secure merchant network in an effective and flexible manner.

Accordingly, there is a need for a method and system for combining multiple financial products on one smart card available through a mobile telephone service provider in a single-branded service.

### SUMMARY

The present invention overcomes the above-noted and other shortcomings by providing a novel and improved method and system that meet the aforementioned needs.

An embodiment of the present invention includes a system for electronic commerce comprising: a transaction card, such as a smart card, wherein the transaction card exchanges data with a wireless communications device (mobile telephone); a first entity (financial institution) wherein the first entity supplies a second entity (mobile telephone service provider) the transaction card for use in the communications device supplied to a consumer by the second entity; wherein the transaction card is used to purchase goods/services over a communications network, such as the Internet. The transaction card stores bundled financial products that are provided under a single brand name and accessed through a proprietary merchant network. The communication device includes an Internet browser and the transaction card comprises data of at least one multiple payment brand for use in an open network. Additionally, the transaction card is associated with a loyalty program for redemption of goods/services and also comprises data regarding a first account associated with a first currency and a second account associated with a second currency. This embodiment further includes a second transaction card, wherein the second transaction card is supplied by the first entity and the second transaction card is associated with an alternative payment brand.

Another embodiment of the present invention includes a system for electronic commerce comprising: means for storing data on a transaction card; means for exchanging data between a communication device and the transaction card; means for transmitting data wirelessly from the communication device; means for making purchases of goods/services with the communication device; and means for debiting an account associated with the transaction card for the purchases.

A further embodiment of the present invention includes a method for conducting electronic commerce, comprising the steps of: supplying a transaction card to a first entity (mobile telephone service provider), wherein the first entity provides the transaction card (smart card) to a consumer; receiving data from the consumer through the first entity regarding an application for a transaction card; conducting a credit analysis regarding the application; and participating with the first entity in an offering of financial products. The financial products are single-branded and this method further provides data to the first entity for loading onto the transaction card, wherein the data comprises a first account associated with a first currency and a second account associated with a second currency.

An embodiment of the present invention further includes a method for activating an account for the consumer, supplying a magnetic strip card in addition to a smart card, and supplying a second transaction card associated with an alternative payment brand.

Another embodiment of the present invention involves a system for electronic commerce comprising: a transaction card associated with a consumer, wherein the transaction card exchanges data with a receiving terminal, e.g., a vending machine, point-of-sale terminal; a “contact-less” integrated circuit within the transaction card; and an antenna embedded within the transaction card; wherein the receiving terminal wirelessly reads data from the transaction card. This embodiment further comprises an inductive loop of low frequency electronic magnetic radiation to provide power to the transaction card. Additionally, the receiving terminal communicates with a payment center gateway to determine whether an account of the consumer is sufficient to carry out a transaction associated with the receiving terminal.

Various advantages and features of embodiments of the present invention are apparent from the description herein. One advantage of an embodiment of the present invention is that a consumer using such a method and system may eliminate the need to carry a large number of credit, debit, cash, and stored value cards.

Another advantage of the present invention is that a mobile telephone service provider may provide a value-added service to its customers by providing pre-packaged financial products. Still another advantage of embodiments of the present invention is that a secure purchase environment for mobile commerce is provided through a proprietary merchant network.

Additional embodiments of the present invention include a mobile payment solution that offers a solution to all Mobile Telephone Service Provider's (MTSP) customers wherein payment funding is enabled through credit, debit, and stored value vehicles. The invention is also open to existing payment brands, e.g., Visa, MasterCard, Diner's Club and establishes a new brand of payment services for mobile commerce (m-commerce) (herein referred to as “LINK”).

Further the invention enables institutions, such as Citibank, and an MTSP to benefit from both existing and new payment brands; employ server-based and “contact-less” chip card solutions for payments in virtual and physical worlds. Embodiments of the present invention further provide: Joint statements for an MTSP's phone bills and m-commerce transactions; loyalty programs such as phone-minute incentives and branded phone programs; and enhanced customer service.

The present invention also encompasses a system and method for using a smart card provided by a bank and available through a mobile telephone service provider in one branded service for use on a secure merchant network accessible through a mobile telephone. A customer obtains a single-brand smart card from a mobile telephone service provider and subsequently purchases goods and services through the network using the smart card, and the bank account or other account associated with the smart card is debited. The customer may purchase goods and services through other facilities as well.

Examples of the market segments that may be served by embodiments of the present invention include: 1) Consumers (any person to which an MTSP markets); 2) Businesses (small, medium, or large); and 3) Service Categories (consumer-to-consumer, consumer-to-business, business-to-consumer, or business-to-business).

Further features of various embodiments of the present invention include: Enabling payments from “any consumer or business” to “any consumer or business;” addressing the payment needs of all customer segments—no customer need be refused. Certain embodiments are open to all payment brands to allow for a critical mass of customers and merchants.

Further advantages and features of the present invention of particular interest to business entities include: 1) Businesses of all sizes from small to large will be able to efficiently deploy corporate expense and travel and entertainment payment tools, while maintaining close control from a central point; 2) The financial control unit of a business can issue a MTSP handset to any employee to use as the traditional communication tool, and to enable them to use the business' chosen entity, e.g., Citibank, MTSP payment products; and 3) Spending can be remotely controlled by value, frequency, merchant, or period.

An example of a further embodiment of the present invention is that an employer can issue mobile telephones with smart cards to its employees. The smart cards will include a cash advance account that may be used for business purposes. Accordingly, when the cash advance account is used by the employee, the employer receives a record of the purchase or use through the account supplier. Further, the company may replenish the cash advance account by communicating with the bank via the Internet or via other means. Thus, instead of supplying cash advances to employees, the employer could supply cash advance accounts using the mobile telephone/smart card system described. Such a system offers improved control, monitoring, and convenience.

Other embodiments of the present invention include loyalty programs whereby, for example, points are awarded and accumulated by users of the invention. These points may be redeemed for phone time, frequent flier miles, and the like. An embodiment of an award system includes 1) allowing the earning of points every time there is usage of the MTSP and associated services and products; 2) providing, for example, two reward options: phone time or mileage; and 3) providing preferential points for use of LINK transactions. Further, an embodiment of the present invention permits accelerated earnings with bonus merchants and behavior; on-line service delivery; and instant redemption.

Various customer service modes are available to users of embodiments of the present invention. They include service over wireless devices, service over the Internet, and service through telephone centers. Further, the present invention provides various customer service activities involving a joint bank and MTSP effort. The customer service activities may include: 1) Account maintenance whereby statements are online or on paper, if required, and consolidated with MTSP phone charges. Strip statementing for business expenses are also provided whereby selection may be made of the various expenses for easy expense management. Other maintenance activities include change of details, address, PIN, etc.; 2) Balance repayments with flexibility whereby customers can provide input on what they want to pay, how much and how often. Standing orders are set and they can be change online at anytime. Payments may be in installments, full balance, and revolving minimum balance; 3) Rewards program including the following features: browse, inquire, redeem, review and enter promotions; 4) Non-traditional payments are available to allow for payment to another person using programs, such as, Citibank's C2IT program, and the transfer of balances to and from other institutions; and 5) CRM promotions, including intelligent behavior/demographic targeted promotions, providing, for example, spend threshold instant and unexpected rewards informed by Email/SMS and credit line management, rewards promotions, etc.

### BRIEF DESCRIPTION OF THE DRAWINGS

The present invention is shown by way of example and not by limitation in the accompanying figures, in which:

FIG. 1 shows an embodiment of the present invention;

FIG. 2 shows an embodiment of a customer acquisition and account opening process of the present invention;

FIG. 3 shows an architecture of an embodiment of the present invention; and

FIG. 4 shows an architecture of another embodiment of the present invention.

### DETAILED DESCRIPTION

Reference will now be made in detail to embodiments of the present invention, one or more examples of which are illustrated in the accompanying figures. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

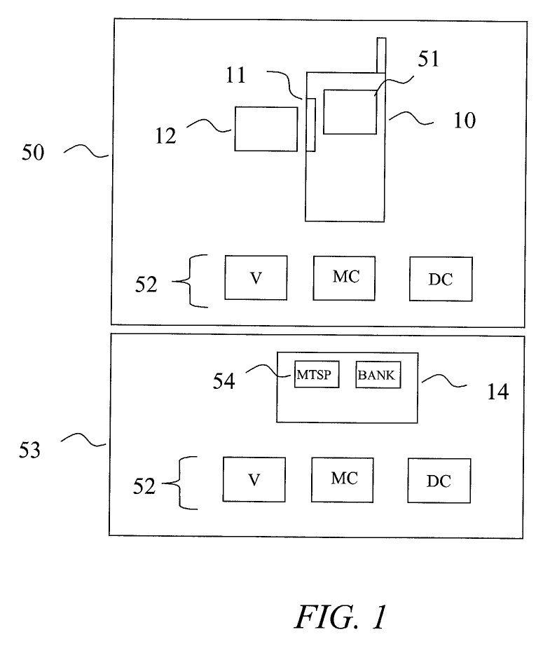

FIG. 1 is directed to a Mobile Telephone Service Provider (MTSP), showing an embodiment of the present invention. The MTSP may be a service provider in the United States, Japan, or other country. The example MTSP described in the detailed description is in Japan. An MTSP may be a telecommunications services provider, such as a provider of wireless telephone service, network access provider, or other communications service provider. The illustrated embodiment is an inventive payment services system herein referred to as “LINK,” which is a branded payment service and merchant network that provides consumers a secure purchase environment for mobile commerce, E-commerce and retail point-of-service (POS) features through a proprietary merchant network and contact-less integrated chip (IC) technology.

FIG. 1 shows a mobile telephone 10 including a receptacle 11 for a smart card (or IC card) 12. The smart card 12 is shown separately from the mobile telephone 10, but in several embodiments the smart card 12 is inserted in the mobile telephone's smart card receptacle 11. The smart card 12 shown comprises a plastic IC card that stores data relating to a combination of financial products, e.g., credit line, cash advance line, stored value, debit capability, and bill payment (also known as “bundled features” or “bundled products”). For example, in relation to credit line data, the smart card 12 includes data describing the credit card type (e.g., VISA, MasterCard, Diner's Club International), a credit card number, expiration date, and name. In the embodiment shown, these bundled financial products are provided under a single-brand name 50 (e.g., in the embodiment shown, LINK) by a single financial institution (e.g., a bank). In an embodiment, these single-brand financial products may be used only in a proprietary merchant network available to users of the products. In other embodiments, these single-brand financial products may be used outside the proprietary merchant network.

The mobile telephone 10 includes an Internet browser. The browser allows the user of the telephone 10 to browse the Internet and to receive displayed data (e.g., web pages). The browser causes such data to be displayed on the display screen 51 of the telephone 10.

Referring again to FIG. 1, in addition to data regarding the financial products under the single-brand name, the smart card 12 also includes data regarding one or more multiple payment brands 52 that may be used outside of the proprietary network (e.g., VISA, MasterCard, or Diners Club). The data regarding the one or more multiple payment brands 52 may comprise a new payment account (e.g., a new credit card account) or any existing customer account (e.g., an existing credit card account).

The customer may also be issued a “real world” 53 plastic credit card 14 associated with one of the multiple payment brands selected. This card 14 includes the brand name of the bank issuing the bundled products and is preferably issued by the same bank as that issuing the bundled products.

Moreover, an embodiment of the smart card 12 records transactions and accumulates points related to usage of the financial products stored thereon. These points may be part of a system for redemption for free goods or services, such as phone time or mileage.

In an embodiment, the single-brand financial products mentioned are provided by a bank (in the embodiment shown, a United States-based bank). The bank carries out a joint venture or similar arrangement with a Mobile Telephone Service Provider (MTSP) 54 in acquiring customers, distributing mobile telephones and smart cards, branding, and in otherwise carrying out a system according to the present invention. In the embodiment shown, the MTSP provides the mobile telephone 10 and related communication services. Moreover, in the embodiment shown, the MTSP is a provider of mobile telephone service and other telecommunications services in Japan, but embodiments include MTSPs at any location.

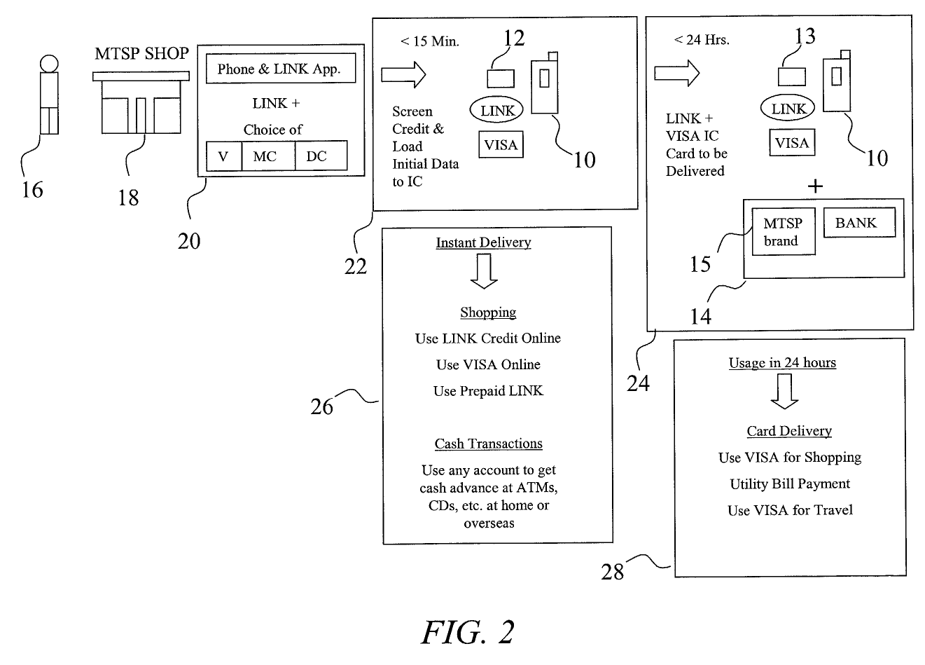

FIG. 2 shows one embodiment of a system according to the present invention that acquires customers, opens accounts, and distributes the mobile telephone 10 and smart card 12. Those of ordinary skill in the art will recognize that there are several methods of carrying out such acquisition, account opening, and distribution, and that a description is provided of one such method to illustrate an embodiment of the present invention. Referring to that which is shown on FIG. 2, a customer 16 visits a physical MTSP Shop 18 (e.g., a retail store operated by the MTSP) and applies for wireless services from the MTSP. At the same time, the customer 16 also applies for mobile-commerce services (m-commerce services) comprising providing the mobile telephone 10, smart card 12, single-branded financial products, and other products and services described above in relation to FIG. 1, and also selects an alternative payment brand (e.g., VISA, MasterCard, or Diner's Club) for general use in m-commerce and storage on the smart card 12. This phone and Link application step is illustrated on FIG. 2 at item 20.

The information (name, address, and other identifying information) provided by the customer in making application for mobile services and for m-commerce services is sent to a data center (e.g., a data center provided by a bank and MTSP alliance) for credit screening while the customer waits in the MTSP shop 18. A decision regarding whether the customer 16 will be provided with m-commerce solutions in the form of the single-branded financial products (and which of the products) is provided to the MTSP shop 18, preferably within 10 minutes of the MTSP shop's transmittal of the customer's data. In the embodiment shown, all customers who apply are provided with the stored value and debit service portions of the financial products, and those who are approved by the data center credit screening are provided with the credit portion of the financial products (e.g., credit card).

Referring still to FIG. 2, once the credit screening process is completed, the subscriber information (i.e., customer identifying information such as name and customer number) is loaded onto the IC chip of the smart card 12 using the smart card read/write hardware on location at the MTSP shop 18. In addition, data regarding the single-brand financial products for which the customer 16 is approved (e.g., credit line, cash advance line, stored value, debit capability, and bill payment services) are written onto the smart card 12 (e.g., account numbers, PIN numbers, and the like).

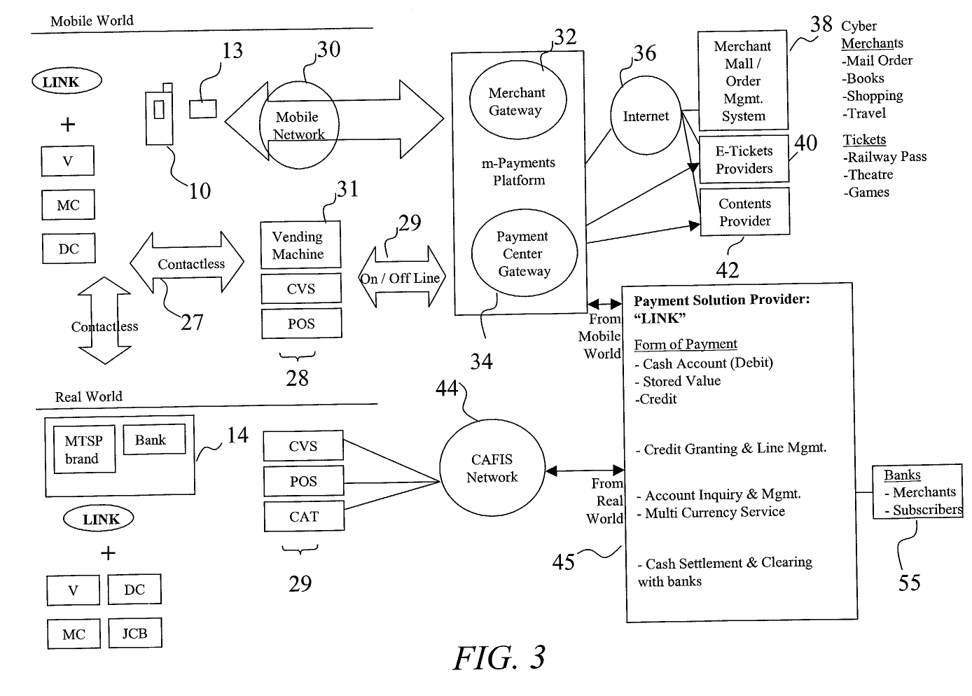

The accounts provided (and written onto the smart card) are also activated at this time on the bank's server in communication with the merchant gateway 34 shown on FIG. 3 (discussed in further detail below). Thus, these accounts are immediately available to the customer.

In an embodiment, multiple types of credit cards (e.g., VISA, Master Card) may be bundled together under a single brand on the smart card 12. Moreover, accounts using different currencies may be bundled together for a customer on a single smart card. For example, an account to be settled in United States dollars may be provided along with a separate account to be settled in Japanese Yen. The customer could use the customer's mobile telephone to choose which of the bundled accounts on the smart card the customer wishes to use for a particular transaction.

Referring again to FIG. 2, the customer 16 is then provided with the mobile telephone 10 and the smart card 12 containing the data written onto the card 12 described above. Preferably, the customer 16 is so provided within 15 minutes after the customer provides the application data to the MTSP shop 18 for wireless service and m-commerce service. This step is embodied in the illustration labeled item 22 of FIG. 2.

When applying for m-commerce services, the customer also selects (e.g., applies for) an alternative payment brand (e.g., VISA, MasterCard, Diners Club) for general use in m-commerce. Data associated with such selection is provided to the appropriate approval center. If approved, a second smart card 13 (IC card) comprising the data written onto the first smart card 12 and data associated with an alternative payment brand (e.g., credit card number, expiration date, and name) is created. Additionally, a physical, plastic card 14 embodying the alternative payment brand is created. Both the second smart card 13 and the alternative payment brand credit card 14 are shipped to the customer at the address provided by the customer on applying for wireless and m-commerce services. Preferably, the second smart card 13 and alternative payment brand credit card 14 are shipped to the customer 16 within 24 hours after the customer provides application data to the MTSP Shop 18. Note that the credit card 14 contains the brand of both the bank (or another entity) and the MTSP 15. The customer 16 then replaces the first smart card 12 issued at the MTSP Shop 18 with the second smart card 13, inserting the second smart card 13 in the mobile telephone 10. These steps are embodied in the illustration shown as item 24 of FIG. 2.

In another embodiment, the MTSP Store comprises an embosser. When the customer 16 is approved for credit, the embosser is used to create a plastic credit card with the appropriate information (account number, name, expiration date).

Referring again to the embodiment shown, as illustrated with item 26 of FIG. 2, upon the customer's receipt 22 of the mobile telephone 10 and smart card 12 from the MTSP Shop 18, the customer 16 may immediately use the single-branded financial products for which the customer 16 is approved. For example, the customer may use the financial products provided to use the credit product online and the stored value product. The customer 16 may also immediately use the single-branded financial products to obtain cash advances at ATMs. As illustrated at item 28, upon receipt of the credit card 14 the customer may use the card for shopping off-line, for bill payment, for travel, and other pursuits.

Of course, the customer may apply for mobile services and mobile commerce services at locations other than the MTSP Shop, and may apply for such services online via the Internet. For example, the customer may provide the required application information online, and then the mobile telephone 10 and smart card 13 will be shipped to the customer, preferably within 24 hours of receipt of the customer's application data.

FIG. 3 illustrates an embodiment of the use of the mobile telephone 10 and smart card 13, as well as of the alternative payment brand credit card 14. A merchant gateway 32 is provided, with which the mobile telephone 10 and smart card 13 communicates through a mobile network 30. The mobile network 30 in the embodiment shown is provided by the MTSP, and the merchant gateway 32 is provided by the bank (or another entity) supplying the single-brand financial products. Likewise, the payment center gateway 34 is also provided by the same bank. Note that the payment center gateway 34 is in communication with servers that store account information in relation to the single-brand financial products (e.g., a server that stores the stored-value balance for the customer's stored-value account).

The merchant gateway 32 comprises an embodiment of that which is shown in U.S. Utility Patent Application Ser. No. 09/728,471, filed Nov. 30, 2000, U.S. Provisional Patent Application Ser. No. 60/168,031, filed Nov. 30, 1999, and U.S. Provisional Patent Application Ser. No. 60/205,318, filed May 18, 2000. The merchant gateway comprises a proprietary e-commerce/m-commerce platform whereby authorized users may access participating merchants, including the ability to purchase goods and services from the participating merchants. The gateway 32 detects the identity of the handset in communication with it (via user name and PIN input by the user of the mobile telephone or other means), and allows those who are authorized to use the gateway 32 to purchase goods and services from merchants and others using the mobile telephone. For example, the mobile telephone user may access the gateway to receive web pages that display goods and services for sale, and may select such goods and services to purchase. The gateway provides purchase information to the payment center gateway to allow for settlement of charges and purchases between the mobile telephone user and the merchant from which the user purchases goods and services. The gateway 32 stores the user's address, identification, account numbers, and related information to facilitate purchases, settlement, and shipment, and is in communication with servers that store account information for its users, including the account information for the bundled products.

In the embodiment shown, the user of the mobile telephone 10 initiates communication with the merchant gateway 32 by dialing a pre-selected telephone number. The mobile telephone 10 (and the smart card 13 that is placed in the smart-card receptacle of the phone 10) communicates with the merchant gateway 32 through the mobile network 30. The merchant gateway 32 receives identifying information from the smart card 13 that identifies the customer using the mobile telephone 10 and allows the merchant gateway 32 to authorize access of the proprietary merchant network associated with the gateway 32.

In the embodiment shown, the merchant gateway 32—once it validates the mobile telephone 10 and smart card 13—allows the user of the telephone 10 to access various merchants, malls, e-ticket providers, content providers, and others 38 that are part of the proprietary network associated with the gateway 32 via the Internet 36.

In the embodiment shown, the customer uses the display on the customer's mobile telephone 10 to browse purchase options. For example, data (e.g., web pages displayable on the mobile telephone display) is downloaded by the mobile telephone via the mobile network 30 and the Internet 36 from a merchant web site 38 that displays purchase options. The customer may choose to purchase goods or services offered by these merchants and others 38 using any of the single-brand financial products that are suitable. For example, the customer may use the credit card facility provided in the single-brand financial products (i.e., the bundled products) to purchase a plane ticket from the e-ticket provider shown. The customer uses the mobile telephone keypad to select the credit card portion of the bundled products for use in the transaction. Upon indication of a desired purchase, the e-ticket provider communicates with the payment center gateway, which carries out the credit card payment function using the credit card account of the customer associated with the smart card 13 in use. The payment center gateway 34 manages such payment, credit granting and line management, account inquiries, and settlement facilitation. Other payment forms associated with the financial products stored on the smart card 13 may be used as well (e.g., debit account or stored value).

The embodiment shown in FIG. 3 also includes a CAFIS Network (Card Authorization Financial Information Systems Network). A customer may use the customer's physical credit card 14 to purchase goods and services through various channels 29 (e.g., retail, point of sale). Those channels 29 communicate with the CAFIS Network 44, which in turn communicates with the payment solution provider network 45, which communicates with the issuing bank 55 to settle the charge.

Embodiments of the present invention also include features whereby the mobile telephone user may check the balance of the accounts associated with the user's smart card. The user may use the mobile telephone to access the merchant gateway 32, which in turn accesses servers containing account information, such as account balance, for the accounts associated with the customer's smart card.

An embodiment of the present invention comprises “contact-less” technology. Referring again to the FIG. 1, the smart card shown 12 comprises a “contact-less” IC card. In an embodiment, the contact-less smart card uses an antenna that is embedded in the body of the card. Embodiments of remote-coupled contact-less smart cards can be read from a receiving terminal within, e.g., 10 cm. An inductive loop of low frequency electronic magnetic radiation provides the operating power to the card.

Referring again to FIG. 3, the “contact-less” smart card 13 is used to carry out commerce functions with physical commercial structures, such as vending machines, point of sale terminals, and retail stores that include a contact-less smart card reader (receiving terminal). In the embodiment shown, for example, a vending machine 31 includes a contact-less smart card reader capable of communicating with the contact-less smart card 13 (without contact). The vending machine 31 is in communication with a payment center gateway 34 via the Internet (in other embodiments, the vending machine 31 is in communication with the payment center gateway 34 via other networking facilities).

In the embodiment shown, the user of the mobile telephone 10 and smart card 13 wishes to purchase a snack from the vending machine 31. The user selects a stored value account as the means of payment by using the menu presented by the mobile telephone 10. The user then approaches the vending machine 31 and passes the mobile telephone (and thus the contact-less smart card 13) near the contact-less smart card reader (receiving terminal) on the vending machine 31. The reader reads the information relating to the stored value account from the smart card, including the identification and stored-value account number. The user then selects the item desired by the user. The vending machine 31 detects the purchase price of the item selected (e.g., US$1.00). The vending machine 31 transmits the stored value account information (e.g., account identification) and purchase price information to the payment center gateway 34 (as indicated by item 29). The payment center gateway 34 receives the information from the vending machine 31 and subtracts the purchase price of the item from the stored value account indicated.

In one embodiment, the payment center gateway 34 receives the information from the vending machine 31, and communicates with the server holding the account information for the account used (i.e., the stored value account) to determine whether a sufficient balance is present to carry out the desired transaction. Once the gateway 34 determines that a sufficient balance is present, the gateway 34 communicates this determination to the vending machine 31. Once the vending machine 31 receives a positive determination from the gateway 34, the machine 31 dispenses the requested item. If the vending machine 31 receives a negative determination from the gateway 34, the machine 31 communicates the negative determination to the user and does not dispense the requested item.

In one embodiment, the payment center gateway receives the information described and transmits the information to the merchant gateway 32, and the merchant gateway credits the merchant account that is associated with the vending machine used.

Various types of contact-less technology may be used in embodiments of the present invention. For example, infrared technology may be used.

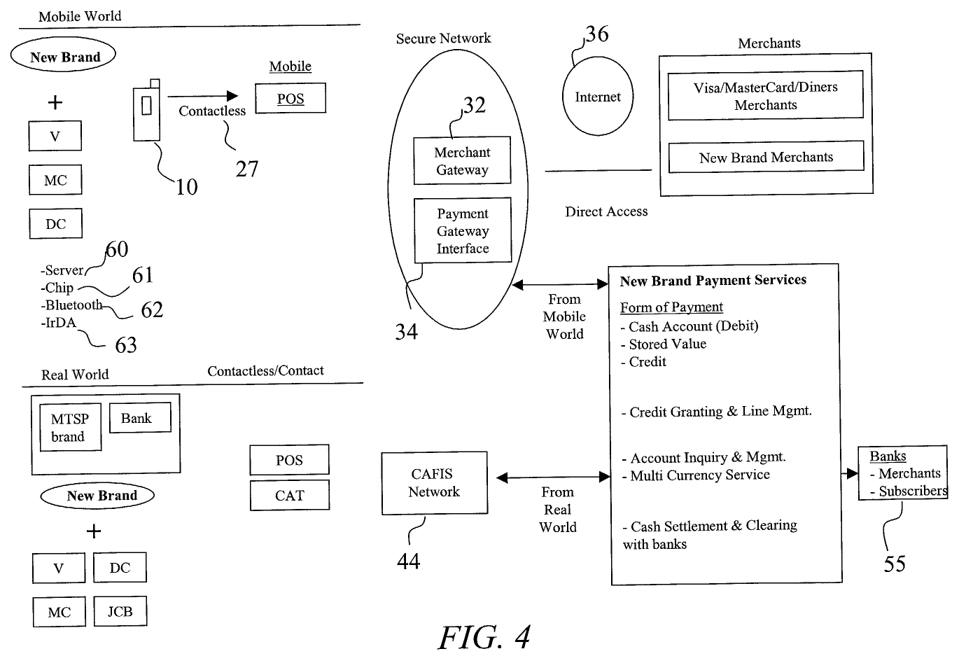

FIG. 4 shows a simplified representation of a top-level architecture for one embodiment of the present invention. It shows many of the same (or similar) elements as shown in FIG. 3, and the associated descriptions above provide a description of many of the elements shown. It should be noted that the mobile telephone shown on FIG. 4 includes a smart card (not shown). It should also be noted that the terms “Server,” 60 “Chip,” 61 “Bluetooth,” 62 and “IrDA” 63 indicate examples of technologies that may be used in conjunction with the mobile telephone in communicating using “contact-less” technology. For example, the smart card used in the mobile telephone may include an IC Chip as described above (“Chip”), radio frequency (RF) broadcasting hardware (e.g., the Bluetooth brand hardware), or infrared data transmitter (e.g., using the IrDA standard). Thus, an embodiment of the present invention may include a smart card having a small RF transmitter for communicating without contact with hardware that includes RF receivers. For example, a vending machine may be equipped with an RF receiver and a mobile telephone having an RF transmitter may communicate with the vending machine as described above with reference to an IC chip. Also, the “New Brand” indicated is a brand owned by the financial institution (e.g., the bank) issuing the bundled products (as is “LINK” mentioned above).

Various embodiments of the invention have been described in fulfillment of the various objects of the invention. It should be recognized that these embodiments are merely illustrative of the principles of the present invention. Numerous modifications and adaptations thereof will be apparent to those skilled in the art without departing from the spirit and scope of the present invention.

I claim:

1. A system for electronic commerce comprising:
a wireless communication device;
a transaction card reader connected to said communication device;
a first entity wherein said first entity provides a consumer said communication device and wherein a second entity supplies said first entity a transaction card for use in said transaction card reader, said transaction card subsequently provided to said consumer; and
wherein said transaction card is used to purchase goods/services over a communications network.

2. The system of claim 1 where said first entity is a mobile telephone service provider.

3. The system of claim 1 where said second entity is a financial institution.

4. The system of claim 1 wherein said communications network is the Internet.

5. The system of claim 1, wherein said transaction card is a smart card.

6. The system of claim 1, wherein said communication device is a mobile telephone.

7. A system for electronic commerce comprising:
a transaction card, wherein said transaction card exchanges data with a wireless communications device;
a first entity wherein said first entity supplies a second entity said transaction card for use in said communications device supplied by said second entity to a consumer;
wherein said transaction card is used by said consumer to purchase goods/services over a communications network.

8. The system of claim 7 where said first entity is a financial institution .

9. The system of claim 7 where said second entity is a mobile telephone service provider.

10. The system of claim 7 wherein said communications network is the Internet.

11. The system of claim 7, wherein said transaction card is a smart card.

12. The system of claim 7, wherein said communication device is a mobile telephone.

13. The system of claim 7, wherein said transaction card stores bundled financial products.

14. The system of claim 13, wherein said bundled financial products are provided under a single brand name.

15. The system of claim 13, wherein said bundled financial products are accessed through a proprietary merchant network.

16. The system of claim 7 further comprising:
an Internet browser associated with said communication device.

17. The system of claim 7, wherein said transaction card comprises data of at least one multiple payment brand for use in an open network.

18. The system of claim 7, wherein said transaction card is associated with a loyalty program for redemption of goods/services.

19. The system of claim 7, wherein said transaction card comprises data regarding a first account associated with a first currency and a second account associated with a second currency.

20. The system of claim 7 further comprising:
a second transaction card, wherein said second transaction card is supplied by said first entity and said second transaction card is associated with an alternative payment brand.

21. A system for electronic commerce comprising:
means for storing data on a transaction card;
means for exchanging data between a communication device and said transaction card;
means for transmitting data wirelessly from said communication device;
means for making purchases of goods/services with said communication device; and
means for debiting an account associated with said transaction card for said purchases.

22. A method for conducting electronic commerce, comprising the steps of:
supplying a transaction card to a first entity, wherein said first entity provides said transaction card to a consumer;
receiving data from said consumer through said first entity regarding an application for a transaction card;
conducting a credit analysis regarding said application; and
participating with said first entity in an offering of financial products.

23. The method of claim 22 wherein said first entity is a mobile telephone service provider.

24. The method of claim 22 wherein said transaction card is a smart card.

25. The method of claim 22 wherein said financial products are single-branded.

26. The method of claim 22 further comprising the step of:
providing data to said first entity for loading onto said transaction card.

27. The method of claim 26 wherein said data comprises a first account associated with a first currency and a second account associated with a second currency.

28. The method of claim 22 further comprising the step of:
activating an account for said consumer.

29. The method of claim 28 further comprising the step of:
supplying a magnetic strip card in addition to a smart card.

30. The method of claim 22 further comprising the step of:
supplying a second transaction card associated with an alternative payment brand.

31. A system for electronic commerce comprising:
a transaction card associated with a consumer, wherein said transaction card exchanges data with a receiving terminal;
a contact-less integrated circuit within said transaction card; and
an antenna associated with said transaction card;
wherein said receiving terminal wirelessly reads data from said transaction card.

32. The system of claim 31 wherein said receiving terminal is a vending machine.

33. The system of claim 31 wherein said receiving terminal is a point-of-sale terminal.

34. The system of claim 31 wherein said antenna is embedded within a body of said transaction card.

35. The system of claim 31 further comprising:
an inductive loop of low frequency electronic magnetic radiation to provide power to said transaction card.

36. The system of claim 31 wherein said receiving terminal communicates with a payment center gateway to determine whether an account of said consumer is sufficient to carry out a transaction associated with said receiving terminal.
